(19) United States
(12) Patent Application Publication
(10) Pub. No.: US 2008/0153589 A1
(43) Pub. Date: Jun. 26, 2008

(54) Rotisserie fantasy league visualization tools

(75) Inventors: Cristobal Baray, Sunnyvale, CA (US); Kelly Hirano, Cupertino, CA (US); Sean Montgomery, Palo Alto, CA (US); Samuel Moreau, Everett, WA (US); Scott B. Ware, Santa Clara, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/644,170

(22) Filed: Dec. 22, 2006

(51) Int. Cl. A63F 13/00

(52) U.S. Cl. 463/30

(57) ABSTRACT

A computer-based method for generating graphical representations of statistics such as player rankings in a fantasy sports game is disclosed. A statistic for a particular team or player is displayed on a graph in a position based on the value of the statistic at a particular time. The graph displays the ranking of the user's team relative to other players in a fantasy sports league. Graphical indicators are displayed to allow the user to visually perceive the difference in ranking between the user's team or player and the next higher or lower ranked team or player. The graph display can be animated to show changes in team or player performance over time by varying the displayed graph to show the statistics for successive time periods.

### CROSS-REFERENCE TO RELATED APPLICATIONS

This application is related to co-assigned U.S. patent application titled “Fantasy Sports Alert Generator”, Ser. No. 11/495,087, filed Jul. 28, 2006, the contents of which are incorporated herein by reference in their entirety.

### BACKGROUND OF THE INVENTION

The present invention relates generally to techniques for displaying quantitative information, and more specifically to techniques for displaying rankings of data values relative to other data values in a data set.

Fantasy games, such as fantasy sports games, have several different types of scoring. One type of scoring is called Rotisserie scoring. Rotisserie scoring for a fantasy league monitors a set of statistics pertinent to the sport (for example, in baseball one league might use: hits, home runs, batting average and pitcher wins; each league is configurable and might use different sets of statistics), tracking them through the season for each fantasy team, scoring teams on how well they match up against each other throughout the season.

Statistics for each fantasy team are typically summed daily or per game cycle, week, or other time period, so a running total of each fantasy team's stats are tracked, for instance, hits, home runs, batting average, and pitcher wins could be tracked. The teams are then sorted per statistic. Then they are given points for their ranking. In a 10 team league, the team with the most hits would get 10 points, the team with the second most would get 9, and the team with the fewest number of hits would get 1 point. Then home runs would be ranked into a numeric order, and points given out in the same manner. That ranking process continues for each statistic used in the league.

A fantasy team's points are summed up across the stats (for example: 6 points for hits, 8 points for home runs, 4 points for batting average, 1 point for pitcher wins) to determine or calculate a fantasy team's total score.

For example, given a 3 team league having the following season statistics:

| Fantasy team | Hits | Home Runs | Batting Average | Pitcher Wins |
|---|---|---|---|---|
| Team A | 45 | 12 | .300 | 14 |
| Team B | 57 | 10 | .302 | 12 |
| Team C | 43 | 8 | .285 | 17 |

A rotisserie league would score these teams as follows:

| Fantasy team | Pts for hits | Pts for HRs | Pts for BA | Pts for Wins | Total |
|---|---|---|---|---|---|
| Team A | 2 | 3 | 2 | 2 | 9 |
| Team B | 3 | 2 | 3 | 1 | 9 |
| Team C | 1 | 1 | 1 | 3 | 6 |

So Team A and B would be tied for the lead, while Team C would be in third place.

Because the way to gain points in this type of league is to move ahead of another team in statistical category, users are interested in knowing one's team performance relative to the other teams. Users often track how much of a lead they have over the fantasy team behind them (if they are in second place, how much of a cushion do they have between them and third place) and how much they need to catch up to the fantasy team ahead of them (by how many home runs (HRs) do they trail the first-place team?). Fantasy users may adjust their play by trying to improve the stat categories that are most likely going to lead to a positive change in their rank order or at least protect their current ranking.

A team's ranking usually varies across stats quite a bit (while a team might be leading in pitcher wins, it might be doing poorly in batting average or home runs) and so the tracking of the positions ahead and behind of a fantasy team varies from stat to stat. And the teams that are above or below the user's team in any stat are usually unique—each stat has their own ranking and so the player would have different teams above and below them in each stat category.

Sorting these numbers and manually tracking the differences is cumbersome and tedious at best. It would be desirable to be able to visualize a team's rotisserie scoring to make evaluating a fantasy user's team relative to its league a simple and enjoyable task for the user.

### BRIEF SUMMARY OF THE INVENTION

In general, in a first aspect, the invention features a computer-enabled method of displaying a visual representation of a ranking of a fantasy sports entity among a set of fantasy sports entities according to a statistical measure. The method includes the steps of displaying a graph segment that represents a set of data values including a current value and a first endpoint value, where the first endpoint value bounds the data values; and the first endpoint value is associated with a first boundary of the graph segment, displaying the current value as a displayed value visually associated with the graph segment, where the location of the displayed value relative to the first endpoint value is based upon the current value, and displaying a first difference magnitude indicator between the current value and an adjacent data value of the set. Embodiments of the invention may include one or more of the following features. The method may further include the step of setting a size of the first difference magnitude indicator based upon the difference between the current value and a first adjacent value, where the first adjacent value is the smallest data value greater than the current value if the first endpoint value is greater than the current value, and the first adjacent value is the largest data value less than the current value if the first endpoint value is less than the current value. The graph segment comprises a segment may have a vertically-oriented major axis, the first boundary may be located adjacent to an upper end of the segment, the second boundary may be located adjacent to a lower end of the segment, the first difference magnitude indicator may be displayed as a shaded rectangular region adjacent to the current value, and a vertical length of the first difference magnitude indicator may be based upon the difference between the current value and the first adjacent value.

The graph segment may include a segment having a horizontally-oriented major axis, the first boundary may be located adjacent to a left end of the segment, the second boundary may be located adjacent to a right end of the segment, the first difference magnitude indicator may be displayed as a shaded rectangular region adjacent to the current value, and the length of the first difference magnitude indicator may be based upon the difference between the current value and the first adjacent value. The method may further include the step of displaying the first endpoint value in the proximity of the first boundary. The set of data values may include includes a second endpoint value, where the second endpoint bounds the data values; the second endpoint value is associated with a second boundary of the graph segment, and the current value is positioned between the first boundary and the second boundary, and the method may further include the step of displaying a second difference magnitude indicator between the current value and the second end of the graph if the current value is not equivalent to the second endpoint value. The method may further include the step of setting the size of the second difference magnitude indicator based upon the difference between the current value and a second adjacent value, where the second adjacent value is the smallest data value greater than the current value if the second endpoint value is greater than the current value, and the second adjacent value is the largest data value less than the current value if the second endpoint value is less than the current value. The method may further include the step of displaying the second endpoint value in the proximity of the second boundary.

The method may further include the step of displaying a line across the graph segment, where the line corresponds to a data value in the set of data values, and the distance between the line and the first boundary is based upon the data value. The statistical measure may include a numeric value based upon the performance of a fantasy sports team, of a sports player, or a combination thereof. The set of data values may be associated with a date.

In general, in a second aspect, the invention features a computer-enabled method of displaying a visual representation of a ranking of a fantasy sports entity among a set of fantasy sports entities according to multiple statistical measures by generating a first graph segment according to the method described in the first aspect above, and generating a second graph segment according to the method described in the first aspect above, where the first graph segment is based upon a first statistical measure, and the second graph segment is based upon a second statistical measure. Embodiments of the invention may include one or more of the following features. The method of may further include aligning the position of the first graph segment with the position of the second graph segment. Aligning nay include aligning the graph segments along a horizontal axis, along a vertical axis, or a combination thereof. The method may further include drawing a connecting segment between a first current value of the first graph segment and a second current value of the second graph segment. The connecting segment may include a line.

In general, in a third aspect, the invention features a computer-enabled method of providing a visualization tool. The method includes the steps of displaying at least one graph segment to illustrate a ranking position of a current value of at least one statistic associated with at least one team, providing a date display for displaying a currently-selected date, where the ranking position is based upon a current value selected from a set of data values, where the data values represent a fantasy sports team's performance on the currently-selected date according to the statistic; and providing a date input feature for allowing a user to change the currently selected date. Embodiments of the invention may include one or more of the following features. The date input feature may include a slider for allowing the user to incrementally change the currently selected date. The method may further comprise the steps of providing a play button feature for allowing the user to select an automatic display mode in which the date is periodically advanced over time to show an animated display of changes in the at least one graph segment over time. The method may further comprise the step of displaying at least one fantasy sports transaction that occurred on the currently-selected date, where the at least one transaction is relevant to the at least one team. The at least one transaction may include Add Player, Drop Player, Update Starting Lineup, Update Starting Roster, Incomplete Roster, Roster Changed, Player Trade, Information Message, News Article, Player Injury Status, or a combination thereof.

In general, in a fourth aspect, the invention features a user interface for displaying a player ranking graph. The user interface includes a first segment representing a first set of data values; where the first segment is associated with a first statistic, a first current value displayed in association with the first segment, where the first current value is included in the first set of data values, and the position of the first current value is based upon the ranking of the first current value in the first set of data values, a first difference magnitude indicator, where the size of the first difference magnitude indicator is based upon the difference between the first current value and a first competitor value, where the first competitor value is included in the first set of data values. Embodiments of the invention may include one or more of the following features. The first competitor value may be selected from the group consisting of the next higher value in the set relative to the current value and the next lower value in the set relative to the current value. The user interface may further include a second segment representing a second set of data values, where the second segment is associated with a second statistic; a second current value displayed in association with the second segment, wherein the second current value is a member of the second set of data values, where the position of the second current value is based upon the ranking of the second current value in the second set of data values, a second difference magnitude indicator, where the size of the second difference magnitude indicator is based upon the difference between the second current value and a second competitor value, where the second competitor value is included in the second set of data values.

In general, in a fifth aspect, the invention features a computer-readable medium comprising instructions for displaying a visual representation of a ranking of a fantasy sports entity among a set of fantasy sports entities according to a statistical measure, the instructions for causing performance of a method comprising the steps of displaying a graph segment that represents a set of data values, where one of the data values is identified as a current value, and one of the data values is identified as a first endpoint value, the first endpoint value bounds the data values; and the first endpoint value is associated with a first boundary of the graph segment, displaying the current value as a displayed value visually associated with the graph segment, where the location of the displayed value relative to the first endpoint value is based upon the current value, and displaying a first difference magnitude indicator between the current value and an adjacent data value of the set.

Embodiments of the invention may include one or more of the following features. A system may include the computer readable medium, and may further include a processor for executing the instructions.

### BRIEF DESCRIPTION OF THE DRAWINGS

FIG. 1A is an illustrative drawing of a data set in accordance with some embodiments of the invention.

FIG. 1B is an illustrative drawing of a graph segment having two difference magnitude indicators in accordance with some embodiments of the invention.

FIGS. 1C and 1D are illustrative drawings of graph segments having one difference magnitude indicator in accordance with some embodiments of the invention.

FIG. 2 is an illustrative drawing of horizontally-oriented graph segment in accordance with some embodiments of the invention.

FIG. 3 is an illustrative drawing of a diagonally-oriented graph segment in accordance with some embodiments of the invention.

FIG. 4 is an illustrative drawing of a curved graph segment in accordance with some embodiments of the invention.

FIG. 5 is an illustrative drawing of a multi-segment ranking graph in accordance with some embodiments of the invention.

FIG. 6 is an illustrative drawing of a piston-format multi-segment ranking graph in accordance with some embodiments of the invention.

FIGS. 7 and 8 are illustrative drawings of a ranking visualization tool user interface in accordance with some embodiments of the invention.

FIG. 9 is an illustrative drawing of an exemplary computer system that may be used in accordance with some embodiments of the invention

FIGS. 10 and 11 are illustrative drawings of ranking graphs in accordance with some embodiments of the invention.

FIG. 12 is a flow diagram of a process for generating a ranking graph segment in accordance with some embodiments of the invention.

### DETAILED DESCRIPTION OF THE INVENTION

The following description is presented to enable any person skilled in the art to make and use the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

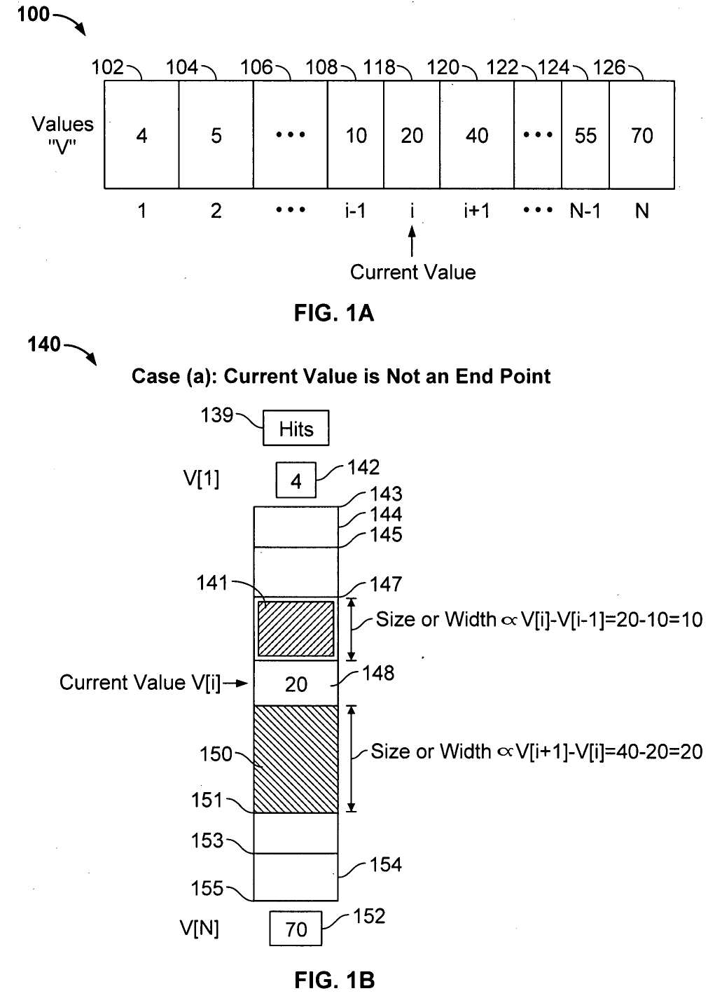

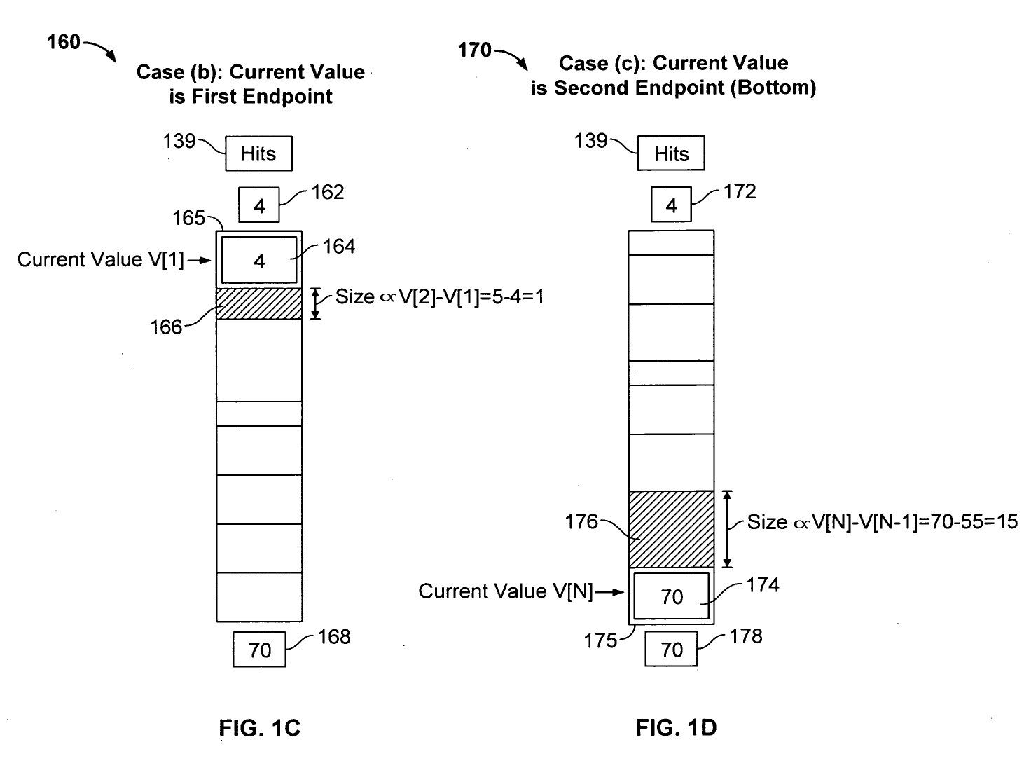

FIG. 1A is an illustrative drawing of a data set in accordance with some embodiments of the invention. In some embodiments, the invention features a method of displaying a visual representation of a ranking of a fantasy sports entity, e.g., a fantasy sports team or a real-life sports team or player, among a set of such fantasy sports entities according to a statistical measure of the entity's performance over a particular time period such as a day. The statistical measure is typically a numeric value based upon the performance of a fantasy sports team or a real-life player in a sport. The statistical measure may be, for example, a number of hits, runs, or walks by a baseball player. A data set 100 provides values for the statistical measure. The values in the data set typically represent particular values of the statistical member for individual entities. For example, for the hits measure, an example data set may contain 7 values, which represent the number of hits accumulated by 7 different teams on a particular day. The sport in this example is baseball. However, in other examples, the sport may be football, hockey, golf, automobile racing, tennis, soccer, or any other sport. Each data value is typically associated with a date, which specifies the date, and, optionally, the time, to which the statistic applies. For example, if a fantasy sports team accumulated 3 home runs on December 5, the Runs statistic would have the value 3 for December 5. In other examples, such as football, the statistics may be on a weekly basis, e.g. the statistics may describe a team's performance in a particular week. In another example, the statistic, e.g., Runs, for a date would show the total statistics for the entire season up to and including that date.

The data set 100 may be, for example, an array stored in a computer memory, or some other data structure that represents an ordered list of values. The array is referred to herein as V, for Values. The array is sortable, and can be viewed in a sorted order, so that the values adjacent in the data set to a current value 118 (referred to as V[i], where V[i] denotes the value at position number i in the array named V) are the next and previous entries in the array, relative to the current value 118. That is, since the array V is sorted in ascending order, the lesser value adjacent to the current value 118 is referenced by V[i−1], and the greater value adjacent to the current value 118 is V[i+1]. The current value 118 is equal to 20, the lesser adjacent value 108 is equal to 10, and the greater current value 120 is equal to 40. Note that for many statistics, such as Hits and Home Runs, greater values represent better performance, so for those statistics, values are typically shown in increasing order, e.g., increasing from the bottom of a graph to the top of the graph or increasing from the left side of a graph toward the right side of a graph. However, for other statistics, such as Earned Run Average (ERA), greater values represent worse performance, so for such statistics, values are typically shown in decreasing order, e.g., decreasing from the bottom of a graph to the top of the graph, or decreasing from the left side of a graph in the direction toward the right side of the graph.

FIG. 1B is an illustrative drawing of a graph segment having two difference magnitude indicators in accordance with some embodiments of the invention. A fantasy sports user is typically interested in the data value for his or her fantasy sports team. The user is also interested in how his or her team's value compares to the values of the same statistic for other teams. Such specific quantitative information about a team's performance, particularly in comparison to competing teams, is valuable to a user because, for example, it provides a basis for making changes to the team, such as changing a player lineup or trading a player.

In one aspect, the method includes the steps of generating the graph segment 140, displaying the current value 148, which is typically overlaid on the graph segment 140, and displaying a difference magnitude indicator 141 to visually indicate the relative difference between the current value 148, e.g., the value for the team of interest to the user, and the next higher or next lower value, i.e., the value of a close competitor, in the data set 100. For example, in the data set 100 of FIG. 1A, which is sorted in increasing order, if the current value 148 corresponds to element 118, which has the value “20”, then the next lower value is element i−1 108, which has the value “10”, and the next higher value is element i+1 120, which has the value “40”.

The graph segment 140 represents the values in a particular data set 100 for a particular statistical measure. One of the data values is identified as a current value 148, which is the value of interest to the user as described above, and one of the data values is identified as a first endpoint value 126, which is ordinarily a maximum or minimum value in the data set. That is, the first endpoint 126 bounds the values in the data set, either from above (a maximum value) or from below (a minimum value). A displayed endpoint value 142 is displayed near a first boundary 144 of the graph segment. The boundary 144 is typically an end of the graph segment 140, e.g., a top end or a right end. However, the boundary 144 may be any region of the graph segment beyond which a value is not likely to increase, e.g., a maximum boundary would typically be the top or right end of the graph segment, and a minimum boundary would typically be the bottom or left end of the graph segment.

The current value 148 is typically displayed in a location that is visually associated with the graph segment 140, e.g., in a rectangular region 148 of the graph segment, in which case the current value 148 appears to be overlaid on a portion of the graph segment 140. The particular portion of the graph segment on which the current value is overlaid is, in one aspect, a function of the current value itself. That is, a current value that is numerically near the maximum value in the data set would be displayed near the top of the data set, and a current value that is numerically near the minimum value in the data set would be displayed near the bottom of the data set. That is, the distance between the displayed value 148 and the first endpoint value 142 is based upon the current value 148. Since the distance between the minimum endpoint value 102 and the maximum endpoint value 126 is typically a fixed value, i.e., the height of the graph segment, if the segment is oriented vertically, the position of the current value on the segment can be measured from either boundary of the segment.

As shown in FIG. 1B, two difference magnitude indicators (DMI's) 141, 150 are typically displayed to visually illustrate the difference between the current value 148 and the next higher value 120 and the next lower value 108 in the set 100. For example, an “upper” DMI 141 would be displayed in a vertically-oriented graph segment if the current value 148 is less than the maximum value 152. Similarly, a “lower” DMI 150 would be displayed if the current value 148 is greater than the minimum value 142.

FIGS. 1C and 1D are illustrative drawings of graph segments having one difference magnitude indicator in accordance with some embodiments of the invention. If a current value 164 is the maximum value in the set, then the current value 164 is displayed at the top of the graph segment 160, and no DMI would be displayed above the current value, since there is no greater value to compare to the current value. In other words, at least one DMI will be displayed if the current value is not equivalent to the first endpoint value. This “first” DMI 166 will be displayed between the current value 164 and the first boundary 165 of the graph segment. Similarly, if a current value 174 is the minimum value in the set, then the current value 174 would be displayed at the bottom of the graph segment 170, and no DMI would be displayed below the current value 174, since there is no lesser value to compare to the current value. If the current value is the only value in the set, then neither the upper DMI 141 nor the lower DMI 150 of FIG. 1B would be displayed. In other words, a DMI will be displayed if the current value is not equivalent to a second endpoint value 174 that corresponds to the “second” boundary 175 of the graph opposite the “first” boundary associated with the first endpoint. For example, if the first endpoint is the maximum value of the data set and is associated with the top of the graph segment, then the second endpoint is the minimum value of the data set, and is associated with the bottom of the graph segment. This “second” DMI 176 will be displayed between the current value and the “second” boundary 175 of the graph segment.

In one aspect, the size of a DMI, e.g., the height of the DMI 149 in a vertical graph segment, is based upon the difference between the current value 148 and the next larger (or smaller) value. The next larger (or smaller) value is referred to as an adjacent value of the current value. If the DMI is to be displayed in the direction of the maximum boundary, i.e., between the current value and the maximum boundary 144, then the size of the DMI 141 is proportional to the difference between the current value 148 and the next larger value 120. Similarly, if the DMI is to be displayed in the direction of the minimum boundary, 154, i.e., between the current value and the maximum boundary, then the size of the DMI 159 is proportional to the difference between the current value 118 and the next smaller value 108. The next larger value is the smallest data value in the data set greater than the current value. The next smaller value is the largest data value in the data set less than the current value. Therefore, the size of the first difference magnitude indicator 141 is set based upon the difference between the current value 148 and a first adjacent value, where the first adjacent value is represented by a line 147. If the first endpoint value is greater than the current value, then the first adjacent value is the smallest data value greater than the current value. If the first endpoint value is less than the current value, then the first adjacent value is the largest data value less than the current value.

As an example, the height of the first DMI 141 on the vertical segment 140 is proportional to the difference between the current value 118 and the previous adjacent value 108. Therefore, the height of the first DMI 141 is proportional to 20−10=10. Similarly, the height of the second DMI 150 is proportional to the difference between the next adjacent value 120 and the current value 118. Because the second DMI represents a larger value, the height of the second DMI 150 is proportional to 40−20=20. As a result, the second DMI 150 is twice the size of the first DMI 141, which indicates that the current value is closer, numerically, to the next lower value 108 than to the next higher value 120.

As shown in FIG. 1B, the graph segment 140 may be a rectangle or segment having a vertically-oriented major axis. In one example, for a vertical graph segment, the first boundary is located adjacent to an upper end of the rectangle, and the second boundary is located adjacent to a lower end of the rectangle. The first difference magnitude indicator 141 is displayed as a shaded rectangular region adjacent to the displayed current value 148, and the height of the first difference magnitude indicator 141 is ordinarily based upon the difference between the current value 118 and the first adjacent value 120. The shading is shown in a diagonal line fill style. Other forms of shading, such as vertical or horizontal lines, or fill patterns, or colors, are also possible.

In accordance with one embodiment, the endpoint values are displayed in the proximity of, i.e., near or at, a corresponding boundary or end of the graph segment. A first endpoint value 142, with the value “4”, is displayed near a boundary 144. Similarly, a second endpoint value 152, with the value “70”, is displayed near a boundary 154.

In one aspect, a horizontal line is displayed across the graph segment for each data value. The location of each line on the data segment is based upon the corresponding data value. For example, the distance between the line and the first boundary may be based upon the data value. In FIG. 1B, a line 143 along the top of the graph represents the minimum endpoint value V[1] 102, where V[1] is the first element of the array A. A line 143 below the line 143 represents V[2] 104. A line 147 represents the adjacent value V[i−1] 108. A box 148 represents the current value 118. A line 151 below the box 148 represents the adjacent value V[i+1] 120, a line 153 represents V[N−1] 124, and a line 155 represents the maximum endpoint value V[N] 126.

A name 139 of the statistic, “Hits”, may be associated with the graph segment 140, and may be displayed in the proximity of, i.e., near, adjacent to, on, behind, etc., the graph segment 140. The name 139 is based upon the statistical measure shown by the graph segment. The statistical measure may be, for example, a statistic in a baseball game, such as comprises Runs, Home Runs, Runs Batted In, Stolen Bases, Batting Average, Wins, Losses, Saves, Strikeouts, or Earned Run Average. The statistical measure may also be a statistic in a football game, such as Rushing Yards, Yards Per Game, Receptions, Receiving Yards, First Downs, Touchdowns, Tackles, Sacks, or Interceptions.

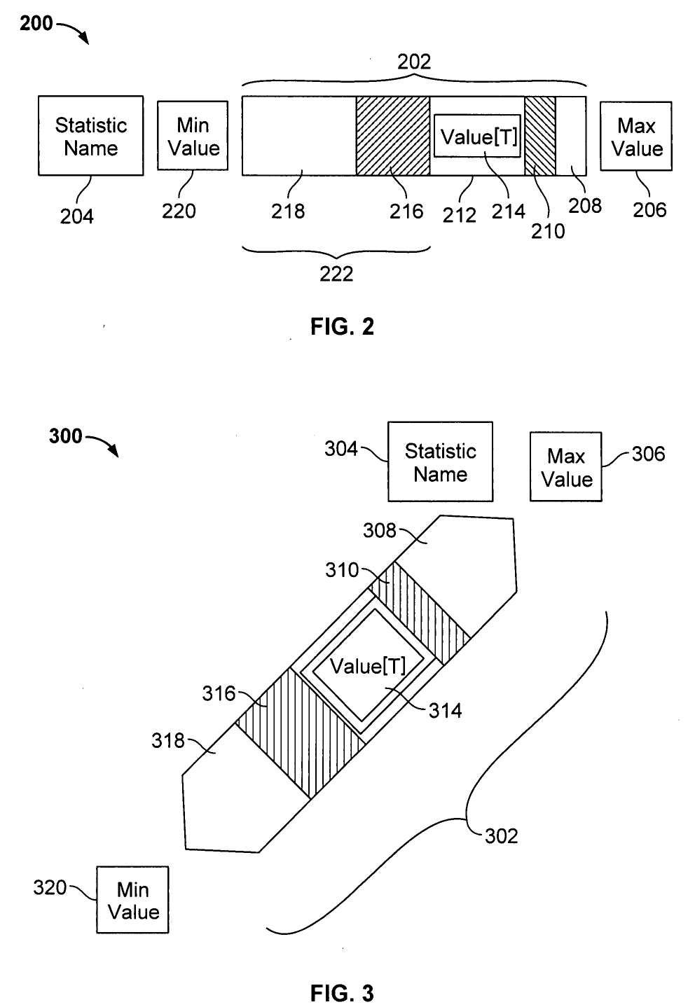

FIG. 2 is an illustrative drawing of horizontally-oriented graph segment in accordance with some embodiments of the invention. The graph segment 222 may be a rectangle having a horizontally-oriented major axis. In one aspect, for a horizontal graph segment, the first boundary is located adjacent to a left end of the rectangle, and the second boundary is located adjacent to a right end of the rectangle. A first difference magnitude indicator 216 is displayed as a shaded rectangular region adjacent to the displayed current value 214. Similar to the example of FIG. 1B, the length of the first difference magnitude indicator 216 is based upon the difference between the current value 118 and the first adjacent value 120.

FIG. 3 is an illustrative drawing of a diagonally-oriented graph segment 300 in accordance with some embodiments of the invention. The diagonal graph segment 300 is generated in essentially the same way as the vertical and horizontal graph segments. A current value 314 may be displayed at points along the diagonal graph segment 300. A first DMI 310 is located between the current value 314 and a first boundary 308. A second DMI 316 is located between the current value 314 and a second boundary 318. In this example, the diagonal graph segment 300 typically represents a single statistic and may be displayed alongside other graph segments.

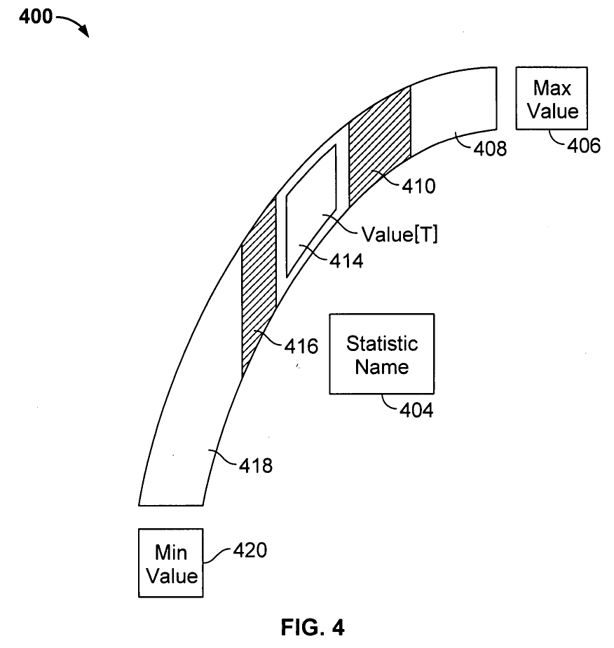

FIG. 4 is an illustrative drawing of a curved graph segment 400 in accordance with some embodiments of the invention. The curved graph segment 400 is generated in essentially the same way as the vertical and horizontal graph segments. A current value 414 may be displayed at points along the curved graph segment 400. A first DMI 410 is located between the current value 414 and a first boundary 408. A second DMI 416 is located between the current value 414 and a second boundary 418. The diagonal graph segment 400 typically represents a single statistic and may be displayed alongside other graph segments.

The shape of a graph segment is not limited to the shapes illustrated here. The graph segment may have a shape of arbitrary geometry, size, and orientation. A shape having at least two points separated by a distance will typically suffice. The graph segment can be drawn along a curved shape, and the path between the two boundaries associated with the endpoints may follow a path along the shape.

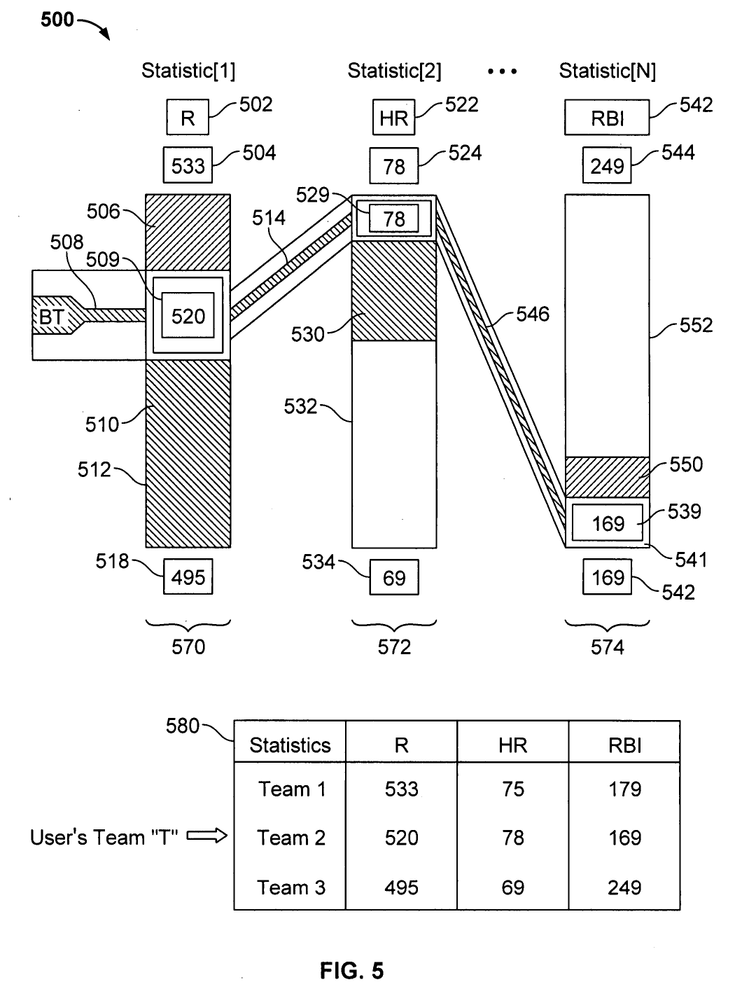

FIG. 5 is an illustrative drawing of a multi-segment ranking graph in accordance with some embodiments of the invention. An example ranking graph 500 includes three graph segments 512, 532, and 552. The segment 512 represents a Runs statistic, as shown by the R label 502. The segment 532 represents a Home Runs statistic, as shown by the HR label 522. The segment 552 represents a Runs Batted In statistic, as shown by the RBI label 542. A statistics table 580 illustrates the data values for the graph 500. The statistics table 580 is shown for illustrative purposes and is not necessarily displayed when the graph 500 is displayed.

In the example of FIG. 5, Team 2 is the currently selected team, so Team 2's statistics are shown as the current values 509, 529, 539. In a first graph segment 572, the current value 509 shows that team 2 is ranked second, because there is a full upper DMI 506 and a full lower DMI 510, both extending from the current value 509. In a second graph segment 572, the current value 529 shows that Team 2 is ranked first in Home Runs. There is no DMI above team 2 in the Home Runs category, and there are two teams ranked below team 2 in Home Runs. The DMI 530 and the region 532 below the current value 529 show that there are two teams ranked lower than team 2 in Home Runs. In a third graph segment 574, the current value 539 shows that Team 2 is ranked last in Runs Batten In. There is no DMI below team 2 in the Runs Batted In category. The DMI 550 and the empty region 552 above the current value 541 indicate that two other teams are ranked above team 2 in runs batted in.

According to one embodiment, the invention features a computer-enabled method of displaying a multi-segment ranking graph 500 that is a visual representation of a ranking of a fantasy sports entity among a set of multiple fantasy sports entities according to multiple statistical measures, such as the graph shown in FIG. 5. The multi-segment ranking graph 500 is generated by generating the first graph segment 570 according to the method described above for generating a graph segment, and generating the second graph segment 572 and the third graph segment 574 according to the same method. Any number of graph segments may be generated by repeating the method for generating a graph segment and displaying the graph segments in different or non-overlapping locations.

Each graph segment represents the values of a statistical measure. In FIG. 5, the first graph segment 570 is based upon a first statistical measure, e.g., Runs. The second graph segment 572 is based upon a second statistical measure, e.g., Home Runs. The third graph segment 574 is based upon a third statistical measure, e.g., runs batted in.

The method of generating a ranking graph may include aligning the position of the first graph segment with the position of the second graph segment. With reference to FIG. 5, aligning may be performed by aligning the graph segments 512, 532, 55 along a horizontal axis or along a vertical axis, so that the segments are lined up along the axis. The method of generating a ranking graph may also include the step of drawing a connecting segment 514 that visually connects the current value 509 of the first graph segment 570 and the current value 529 of the second graph segment 572. In one aspect, the connecting segment is a line, which may be either curved or straight. Connecting segments 514, 546 may be drawn between each pair of adjacent graph segments 570, 572, 574. A second connecting segment 546 visually connects the current value 529 of the second segment 534 to the current value 539 of the graph segment 574.

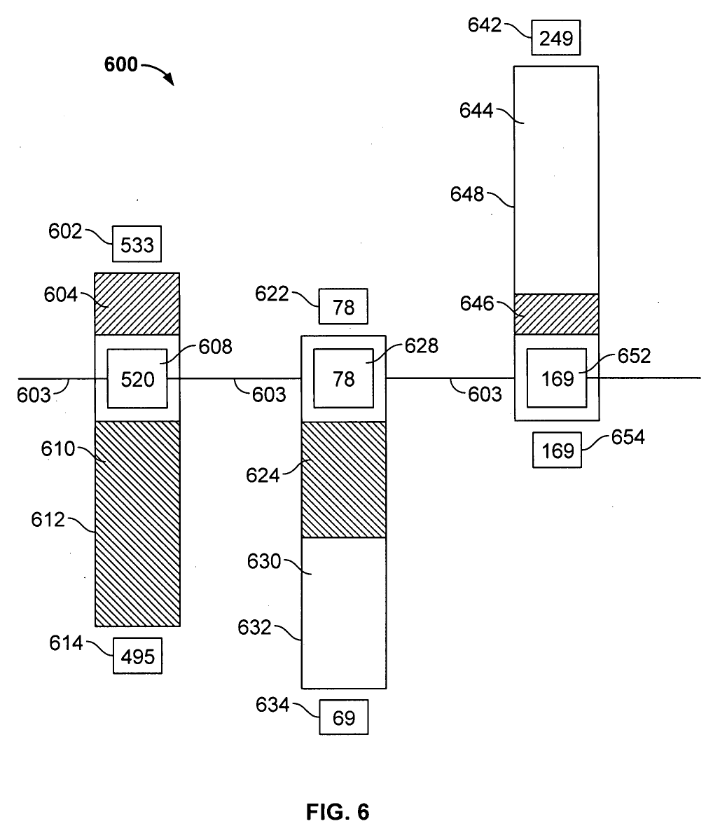

FIG. 6 is an illustrative drawing of a piston-format multi-segment ranking graph 600 in accordance with some embodiments of the invention. The piston format graph 600 is an alternative to the format shown in FIG. 5. Each graph segment 612, 633, 648 in the piston-format graph 600 is vertically aligned with a reference line 603 so that the current values 608, 628, 652 are vertically aligned with each other. Aside from the alignment of the segments, the other features of the piston-format graph are similar to those of the graph 500 shown in FIG. 5.

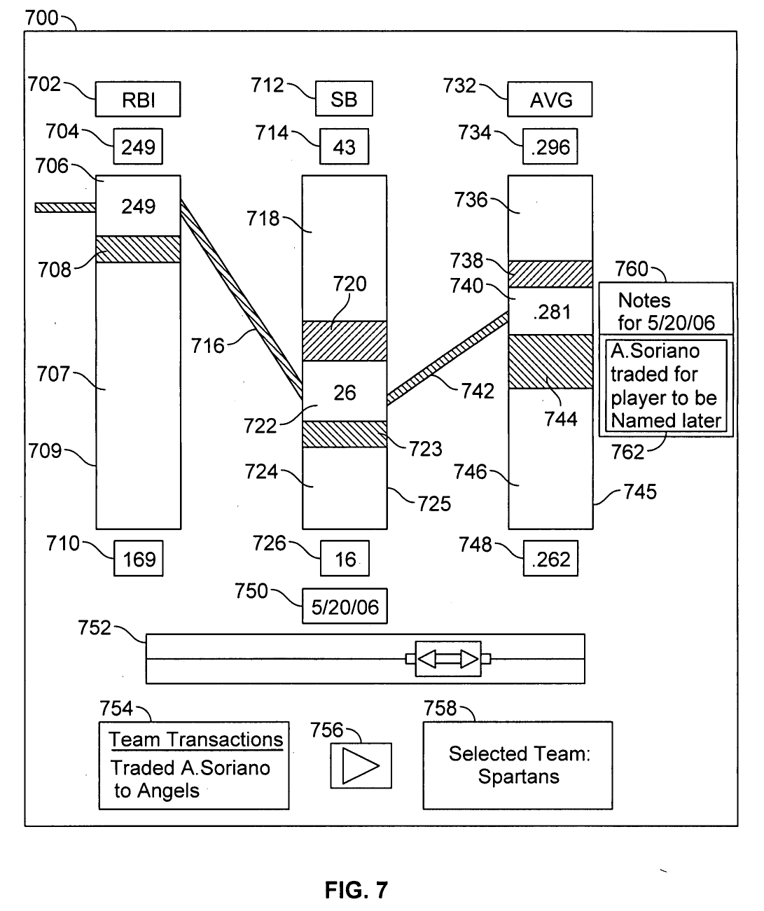

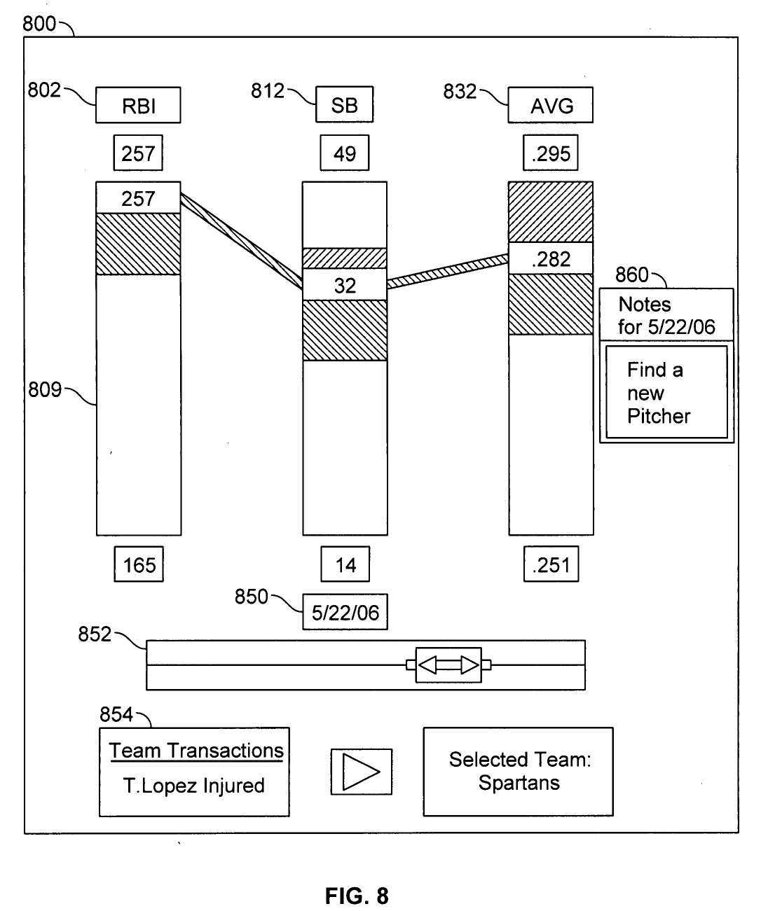

FIGS. 7 and 8 are illustrative drawings of a ranking visualization tool user interface 700, 800 in accordance with some embodiments of the invention. FIG. 7 shows a user interface 700 for a first date 750. FIG. 8 shows a view of the user interface 800 for a second date 850. The ranking graphs show different rankings in the two figures because the rankings have changed between the two dates. The user can change the date for which rankings are shown by moving a slider feature 752 included with the user interface 700. Moving the slider 752 to the right increases the date value, i.e., moves forward in time. Moving the slider 752 to the left decreases the date value, i.e., moves backward in time. Selecting a play feature 756 causes the visualization tool 700 to automatically display the ranking graph for each known date in sequence. That is, in one aspect, the visualization tool 700 displays an animation of the rankings shown by the graph segments 709, 725, 745. The positions of the current values 708, 722, 740 change as the current values themselves change with the date 750 during the animation.

In accordance with one embodiment, the visualization tool 700 may display a fantasy sports transaction that occurred on the currently-selected date in a transaction viewer 754. Transactions are generally operations that users perform on their fantasy sports teams. Transactions may also be events generated by the fantasy sports game itself, such as notifications of injuries and suggestions of transactions that may improve a team's performance. For example, in FIG. 7, a player trade transaction occurred on the selected date 750, and the transaction viewer 754 displays text describing the transaction: “Traded A. Soriano to Angels.” Fantasy sports transactions are described in co-assigned U.S. patent application titled “Fantasy Sports Alert Generator”, Ser. No. 11/495,087, filed Jul. 28, 2006. Examples of transactions include Add Player, Drop Player, Update Starting Lineup, Update Starting Roster, Incomplete Roster, Roster Changed, Player Trade, Information Message, News Article, and Player Injury Status transactions.

A transaction will ordinarily be shown in the transaction viewer 754 only if it is relevant to a selected team. In one aspect, the selected team is selected by a user, and is the same team for which the current values 706, 722, 740 are displayed. A transaction is ordinarily related to a team if the team is a participant in the transaction, or if a player on the team is a participant in the transaction. For example, an Add Player transaction that adds a player to the Fighting Spartans is relevant to the Fighting Spartans team. A Trade Player transaction that adds a player to the Fighting Spartans team from the Angels team is relevant to both the Fighting Spartans and the Angels.

The visualization tool user interface 700 may also include a notes feature 760, which allows the user to associate notes, e.g., text, with the selected date 750. For example, a note 762 has the text “A. Soriano traded for player to be named later.”

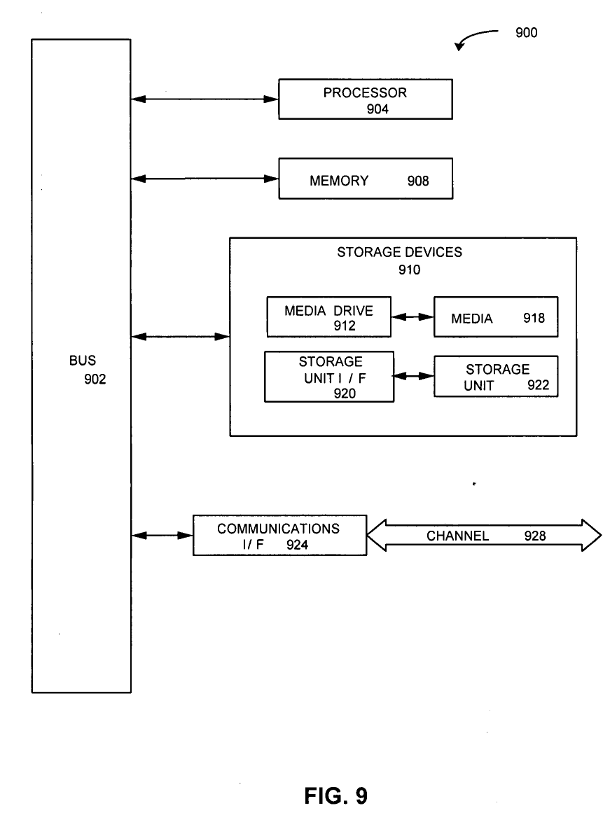

FIG. 9 is an illustrative drawing of an exemplary computer system that may be used in accordance with some embodiments of the invention. FIG. 9 illustrates a typical computing system 900 that may be employed to implement processing functionality in embodiments of the invention. Computing systems of this type may be used in clients and servers, for example. Those skilled in the relevant art will also recognize how to implement the invention using other computer systems or architectures. Computing system 900 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 900 can include one or more processors, such as a processor 904. Processor 904 can be implemented using a general or special purpose processing engine such as, for example, a microprocessor, microcontroller or other control logic. In this example, processor 904 is connected to a bus 902 or other communication medium.

Computing system 900 can also include a main memory 908, such as random access memory (RAM) or other dynamic memory, for storing information and instructions to be executed by processor 904. Main memory 908 also may be used for storing temporary variables or other intermediate information during execution of instructions to be executed by processor 904. Computing system 900 may likewise include a read only memory (“ROM”) or other static storage device coupled to bus 902 for storing static information and instructions for processor 904.

The computing system 900 may also include information storage system 910, which may include, for example, a media drive 912 and a removable storage interface 920. The media drive 912 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 918, may include, for example, a hard disk, floppy disk, magnetic tape, optical disk, CD or DVD, or other fixed or removable medium that is read by and written to by media drive 914. As these examples illustrate, the storage media 918 may include a computer-readable storage medium having stored therein particular computer software or data.

In alternative embodiments, information storage system 910 may include other similar components for allowing computer programs or other instructions or data to be loaded into computing system 900. Such components may include, for example, a removable storage unit 922 and an interface 920, such as a program cartridge and cartridge interface, a removable memory (for example, a flash memory or other removable memory module) and memory slot, and other removable storage units 922 and interfaces 920 that allow software and data to be transferred from the removable storage unit 918 to computing system 900.

Computing system 900 can also include a communications interface 924. Communications interface 924 can be used to allow software and data to be transferred between computing system 900 and external devices. Examples of communications interface 924 can include a modem, a network interface (such as an Ethernet or other NIC card), a communications port (such as for example, a USB port), a PCMCIA slot and card, etc. Software and data transferred via communications interface 924 are in the form of signals which can be electronic, electromagnetic, optical or other signals capable of being received by communications interface 924. These signals are provided to communications interface 924 via a channel 928. This channel 928 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product,” “computer-readable medium” and the like may be used generally to refer to media such as, for example, memory 908, storage device 918, or storage unit 922. These and other forms of computer-readable media may be involved in storing one or more instructions for use by processor 904, to cause the processor to perform specified operations. Such instructions, generally referred to as “computer program code” (which may be grouped in the form of computer programs or other groupings), when executed, enable the computing system 900 to perform features or functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 900 using, for example, removable storage drive 914, drive 912 or communications interface 924. The control logic (in this example, software instructions or computer program code), when executed by the processor 904, causes the processor 904 to perform the functions of the invention as described herein.

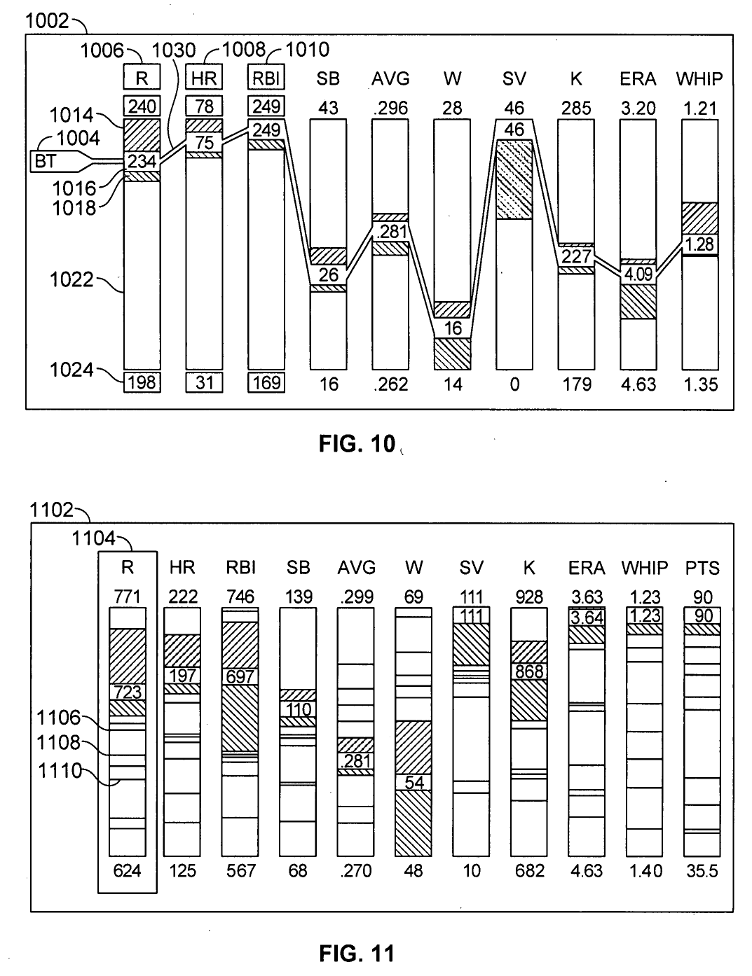

FIGS. 10 and 11 are illustrative drawings of ranking graphs in accordance with some embodiments of the invention. FIG. 10 shows a ranking graph that has 10 graph segments. The current values of the graph segments are connected by lines. An upper DMI 1014 is displayed in with dark shading, and a lower DMI 1018 is displayed with light shading. FIG. 11 shows a ranking graph with horizontal lines 1106, 1108, 1110 that display the locations of corresponding data values.

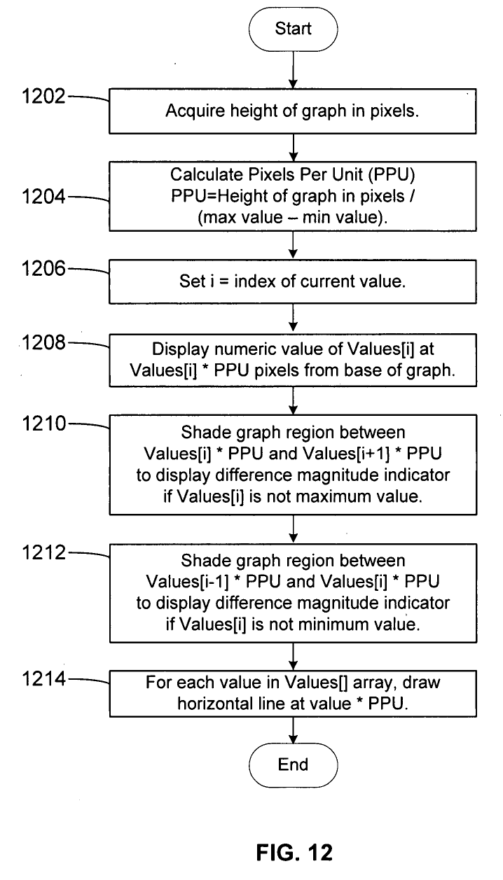

FIG. 12 is a flow diagram of a process for generating a ranking graph segment in accordance with some embodiments of the invention. Block 1202 acquires the height of the graph, e.g., in pixels. Block 1204 calculates a number of pixels per data value unit (PPU) by dividing the height of the graph in pixels by the difference between the maximum data value and the minimum data value. Block 1206 sets a variable i to the index of the current value in an array “Values” of data values. Block 1208 displays the numeric value of Values[i] at Values[i]*PPU pixels from the base of the graph. Block 1210 shades, highlights, emphasizes, colors, or otherwise distinguishes the graph region between Values[i]*PPU pixels and Values[i+1]*PPU pixels to display a first difference magnitude indicator if Values[i] is not the maximum value in the Values array. Block 1212 shades the graph region between Values[i−1]*PPU and Values[i]*PPU to display a second difference magnitude indicator if Values[i] is not the minimum value. Block 1214 draws a horizontal line at Values [i]*PPU for each entry i in the Values array. Note that the pixels per unit value (PPU) may be multiplied by an appropriate scale value to scale the size of the graph as appropriate for the display size.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A computer-enabled method of displaying a visual representation of a ranking of a fantasy sports entity among a set of fantasy sports entities according to a statistical measure, comprising the steps of:
displaying a graph segment that represents a set of data values including a current value and a first endpoint value, wherein the first endpoint value bounds the data values; and the first endpoint value is associated with a first boundary of the graph segment;
displaying the current value as a displayed value visually associated with the graph segment, wherein the location of the displayed value relative to the first endpoint value is based upon the current value; and
displaying a first difference magnitude indicator between the current value and an adjacent data value of the set.

2. The method of claim 1, further comprising the step of:
setting a size of the first difference magnitude indicator based upon the difference between the current value and a first adjacent value,
wherein the first adjacent value is the smallest data value greater than the current value if the first endpoint value is greater than the current value, and
the first adjacent value is the largest data value less than the current value if the first endpoint value is less than the current value.

3. The method of claim 2, wherein the graph segment comprises a segment having a vertically-oriented major axis,
the first boundary is located adjacent to an upper end of the segment,
the second boundary is located adjacent to a lower end of the segment,
the first difference magnitude indicator is displayed as a shaded rectangular region adjacent to the current value, and
a vertical length of the first difference magnitude indicator is based upon the difference between the current value and the first adjacent value.

4. The method of claim 2, wherein the graph segment comprises a segment having a horizontally-oriented major axis,
the first boundary is located adjacent to a left end of the segment,
the second boundary is located adjacent to a right end of the segment,
the first difference magnitude indicator is displayed as a shaded rectangular region adjacent to the current value, and
the length of the first difference magnitude indicator is based upon the difference between the current value and the first adjacent value.

5. The method of claim 1, further comprising the step of:
displaying the first endpoint value in the proximity of the first boundary.

6. The method of claim 1, wherein the set of data values includes a second endpoint value, wherein the second endpoint bounds the data values; the second endpoint value is associated with a second boundary of the graph segment, and the current value is positioned between the first boundary and the second boundary, further comprising the step of:
if the current value is not equivalent to the second endpoint value, displaying a second difference magnitude indicator between the current value and the second end of the graph.

7. The method of claim 6, further comprising the step of:
setting the size of the second difference magnitude indicator based upon the difference between the current value and a second adjacent value,
wherein the second adjacent value is the smallest data value greater than the current value if the second endpoint value is greater than the current value, and
the second adjacent value is the largest data value less than the current value if the second endpoint value is less than the current value.

8. The method of claim 6, further comprising the step of:
displaying the second endpoint value in the proximity of the second boundary.

9. The method of claim 1, further comprising the step of:
displaying a line across the graph segment, wherein the line corresponds to a data value in the set of data values, and the distance between the line and the first boundary is based upon the data value.

10. The method of claim 1, wherein the statistical measure comprises a numeric value based upon the performance of a fantasy sports team, of a sports player, or a combination thereof.

11. The method of claim 1, wherein the set of data values is associated with a date.

12. A computer-enabled method of displaying a visual representation of a ranking of a fantasy sports entity among a set of fantasy sports entities according to multiple statistical measures by generating a first graph segment according to the method of claim 1, and generating a second graph segment according to the method of claim 1,
wherein the first graph segment is based upon a first statistical measure, and the second graph segment is based upon a second statistical measure.

13. The method of claim 12, further comprising:
aligning the position of the first graph segment with the position of the second graph segment.

14. The method of claim 13, wherein aligning comprises aligning the graph segments along a horizontal axis, along a vertical axis, or a combination thereof.

15. The method of claim 12, further comprising the step of:
drawing a connecting segment between a first current value of the first graph segment and a second current value of the second graph segment.

16. The method of claim 15, wherein the connecting segment comprises a line.

17. A computer-enabled method of providing a visualization tool, comprising the steps of:
displaying at least one graph segment to illustrate a ranking position of a current value of at least one statistic associated with at least one team;
providing a date display for displaying a currently-selected date,
wherein the ranking position is based upon a current value selected from a set of data values;
wherein the data values represent a fantasy sports team's performance on the currently-selected date according to the statistic; and
providing a date input feature for allowing a user to change the currently selected date.

18. The method of claim 17, wherein the date input feature comprises a slider for allowing the user to incrementally change the currently selected date.

19. The method of claim 17, further comprising the steps of:
providing a play button feature for allowing the user to select an automatic display mode in which the date is periodically advanced over time to show an animated display of changes in the at least one graph segment over time.

20. The method of claim 17, further comprising the step of:
displaying at least one fantasy sports transaction that occurred on the currently-selected date, wherein the at least one transaction is relevant to the at least one team.

21. The method of claim 20, wherein the at least one transaction comprises Add Player, Drop Player, Update Starting Lineup, Update Starting Roster, Incomplete Roster, Roster Changed, Player Trade, Information Message, News Article, Player Injury Status, or a combination thereof.

22. A user interface for displaying a player ranking graph, the user interface comprising:
a first segment representing a first set of data values; wherein the first segment is associated with a first statistic;
a first current value displayed in association with the first segment, wherein the first current value is included in the first set of data values, and the position of the first current value is based upon the ranking of the first current value in the first set of data values;
a first difference magnitude indicator, wherein the size of the first difference magnitude indicator is based upon the difference between the first current value and a first competitor value, wherein the first competitor value is included in the first set of data values.

23. The user interface of claim 22, wherein the first competitor value is selected from the group consisting of the next higher value in the set relative to the current value and the next lower value in the set relative to the current value.

24. The user interface of claim 22, further comprising:
a second segment representing a second set of data values, wherein the second segment is associated with a second statistic;
a second current value displayed in association with the second segment, wherein the second current value is a member of the second set of data values,
wherein the position of the second current value is based upon the ranking of the second current value in the second set of data values; and
a second difference magnitude indicator, wherein the size of the second difference magnitude indicator is based upon the difference between the second current value and a second competitor value, and the second competitor value is included in the second set of data values.

25. A computer-readable medium comprising instructions for displaying a visual representation of a ranking of a fantasy sports entity among a set of fantasy sports entities according to a statistical measure, the instructions for causing performance of a method comprising the steps of:
displaying a graph segment that represents a set of data values, wherein one of the data values is identified as a current value, and one of the data values is identified as a first endpoint value, wherein the first endpoint value bounds the data values; and the first endpoint value is associated with a first boundary of the graph segment;
displaying the current value as a displayed value visually associated with the graph segment, wherein the location of the displayed value relative to the first endpoint value is based upon the current value; and
displaying a first difference magnitude indicator between the current value and an adjacent data value of the set.

26. The computer-readable medium of claim 25, the method further comprising:
setting a size of the first difference magnitude indicator based upon the difference between the current value and a first adjacent value,
wherein the first adjacent value is the smallest data value greater than the current value if the first endpoint value is greater than the current value, and
the first adjacent value is the largest data value less than the current value if the first endpoint value is less than the current value.

27. A system comprising the computer readable medium of claim 25, and further comprising a processor for executing the instructions.

28. A computer-readable medium comprising instructions for providing a visualization tool, the instructions for causing performance of a method comprising the steps of:
displaying at least one graph segment to illustrate a ranking position of a current value of at least one statistic associated with at least one team;
providing a date display for displaying a currently-selected date, wherein the ranking position is based upon a current value selected from a set of data values;
wherein the data values represent a fantasy sports team's performance on the currently-selected date according to the statistic; and
providing a date input feature for allowing a user to change the currently selected date.

29. A system comprising the computer readable medium of claim 28, and further comprising a processor for executing the instructions.
